(19) United States
(12) Patent Application Publication
(10) Pub. No.: US 2016/0357822 A1
(43) Pub. Date: Dec. 8, 2016

(54) USING LOCATIONS TO DEFINE MOMENTS

(71) Applicant: Apple Inc., Cupertino, CA (US)

(72) Inventors: Nicholas J. Woods, San Francisco, CA (US); Elliott B. Harris, San Francisco, CA (US); Justin S. Titi, Morgan Hill, CA (US)

(21) Appl. No.: 14/733,663

(22) Filed: Jun. 8, 2015

(51) Int. Cl. G06F 17/30

(52) U.S. Cl. CPC G06F 17/30528; G06F 17/30486; G06F 17/30241

(57) ABSTRACT

Disclosed herein are systems, methods, and non-transitory computer-readable storage media for organizing media items according to a contextual moment in which they were captured. Media items can be tagged with unique moments by using temporal data and location data to define moments and to partition collections of media items by the moment they were captured.

### BACKGROUND

1. Technical Field

The present disclosure relates to grouping media items. More specifically, the present technology relates to using temporal data and location data to group media items.

2. Introduction

With increased usage of digital cameras, people capture, store, share, download, or otherwise accumulate a lot of media data. Traditional metadata can be used to organize captured media. However, the context of a moment in which the media is captured is not reflected in traditional metadata.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for organizing media items according to a contextual moment in which they were captured. Media items can be recognized as belonging a unique moment by using temporal data and location data to define moments and to partition collections of media items by the moment they were captured. Media items can also be tagged to indicate that the media item was captured before or after a significant location change. Significant location change tags can be used to further partition a collection of media items into unique moments.

Some embodiments of the present technology involve a camera equipped with location determining technology for gathering information about locations the camera visits and associating images in a collection with moments. When the camera determines that the location in which an image is captured is significant, a moment generation module can further partition the collection of media items.

In some embodiments of the present technology, determining that the location is significant involves determining when the location is a location that is visited for at least a predetermined period of time or when the location is a familiar location (e.g. a user's home) or an a priori significant location (e.g. a landmark).

The present technology can also involve determining that the location is significant when the location is a frequently visited location. Determining that a location is frequently visited can involve gathering information including location coordinates, a location name, a count indicating a number of times the electronic device visited the location, a date associated with each of the visits, and a duration indication associated with each of the visits.

A frequently visited place can also involve a more precise, sub-location included in the location and some embodiments of the present technology can involve identifying time spent at sub-location as a unique moment when the sub-location is visited a predetermined number of times and partitioning the collection of media items stored in the media storage using a unique moment tag for the sub-location.

Some embodiments of the present technology involve a privacy protection feature that involves generating a new significant location tag for each significant location transition even if the location is the same as a previously visited location.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary electronic device for capturing images, gathering moment-defining data about captured images, recognizing that the captured images belong to a unique moment, and displaying a user interface of images organized into moments;

FIG. 2 illustrates an example of a moment-view interface for presenting a collection of media items based on the moment a media item is captured;

FIGS. 3A, 3B, 3C, 3D, and 3E illustrate examples of a graphical user interface for enabling and exploring a group of frequent location logged in an electronic device according to some embodiments of the present technology;

FIG. 4 illustrates an electronic device for capturing images and partitioning a collection of images into unique moments using frequent location data;

FIG. 5A illustrates a method of partitioning a collection of images into unique moments using frequent location data according to some embodiments of the present technology;

FIG. 5B illustrates a method of generating moments using frequent location data and sub-location data according to some embodiments of the present technology; and

FIG. 6A and FIG. 6B illustrate exemplary possible system embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

As used herein, the term “moment” shall refer to a contextual organizational schema used to group media items for the purpose of displaying a collection of media items according to inferred or explicitly-defined relatedness between media items. The present disclosure addresses the need in the art for ways to define moments for organizing media items. Accordingly, some embodiments of the present technology involve using temporal data and location data to recognize more precisely when media items are contextually related and to partition moment collections into more specific moments.

In some embodiments of the present technology, an electronic device can gather data that is used to partition moments in time and a collection of media items is presented in a user interface that displays the media according to discrete moments in time. The electronic device can be used to gather moment-defining data as well as capture media items. Additionally, in some cases, the electronic device can be used to gather the moment-defining data and the electronic device can provide the gathered data to other media capture devices.

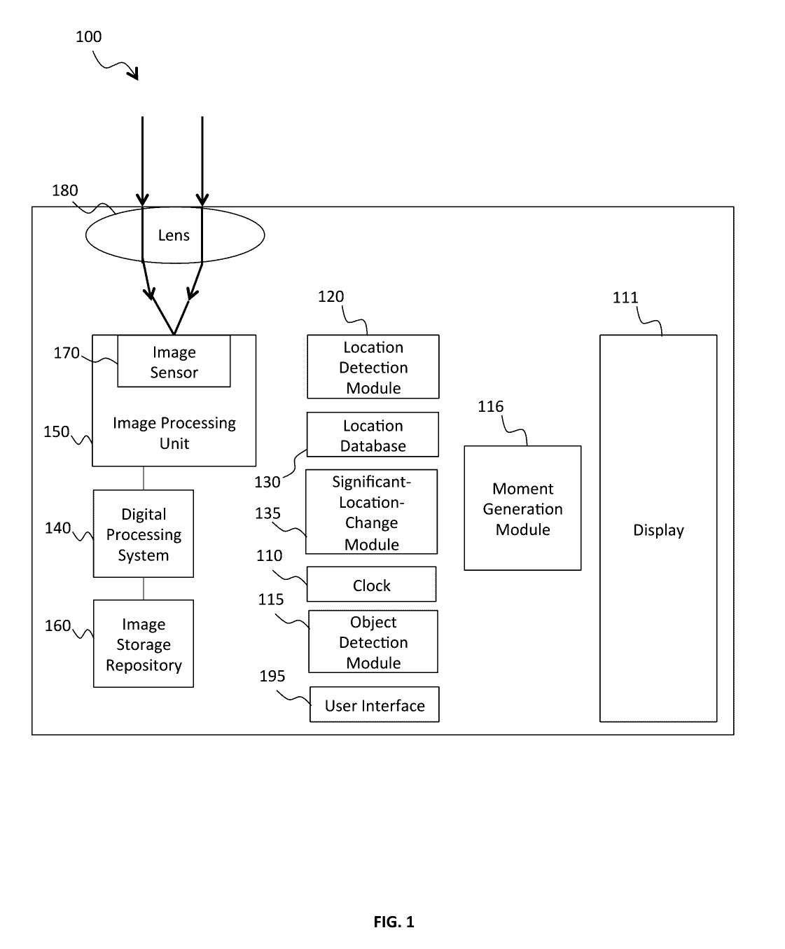

FIG. 1 illustrates an exemplary electronic device 100 for capturing images, gathering moment-defining data about captured images, tagging the captured images with the moment-defining data, and displaying a user interface of images organized into moments.

The electronic device 100 includes a lens 180, an image sensor 170, and an image-processing unit 150. The image-processing unit 150 receives image data from the image sensor 170 and a digital processing system 140 processes the image data into a captured image and stores captured images in a image storage repository 160.

The electronic device 100 can also include a clock 110 and an image can be tagged with temporal data indicating when the image is captured. Also, an electronic device 100 can include a location detection module 120 for detecting the location of the electronic device. For example, the location detection module 120 can be configured to detect the location of the electronic device using cell tower triangulation, GPS positioning, or WiFi access point information, etc. The electronic device 100 can tag an image with location data when the image is captured.

Similarly, the electronic device 100 can include a location database 130 that stores information about places the electronic device is located and can include a significant-location-change module 135 for determining when the electronic device makes significant location changes.

Additionally, the electronic device 100 can include an object detection module 115 configured to detect objects in a captured image. For example, the object detection module 115 can recognize faces and the electronic device can tag images with information about the faces detected therein.

Furthermore, the electronic device 100 can include a user interface 195 and media items can be edited with user-defined data about the time of media capture, location, objects in a captured media item, people in a captured media item, etc.

Additionally, the electronic device 100 can include a moment generation module 116 configured to use the information gathered by the electronic device 100 to organize the captured images into moments on a display 111.

In some embodiments of the present technology, the moment generation module 116 examines temporal information for a group of images and determines that images with timestamps having a predetermined closeness in time belong to the same moment. In some embodiments, the moment generation module 116 determines a significant location change from the first time to the second time defines a partition in a collection of images captured on opposite sides of the partition belong to separate moments.

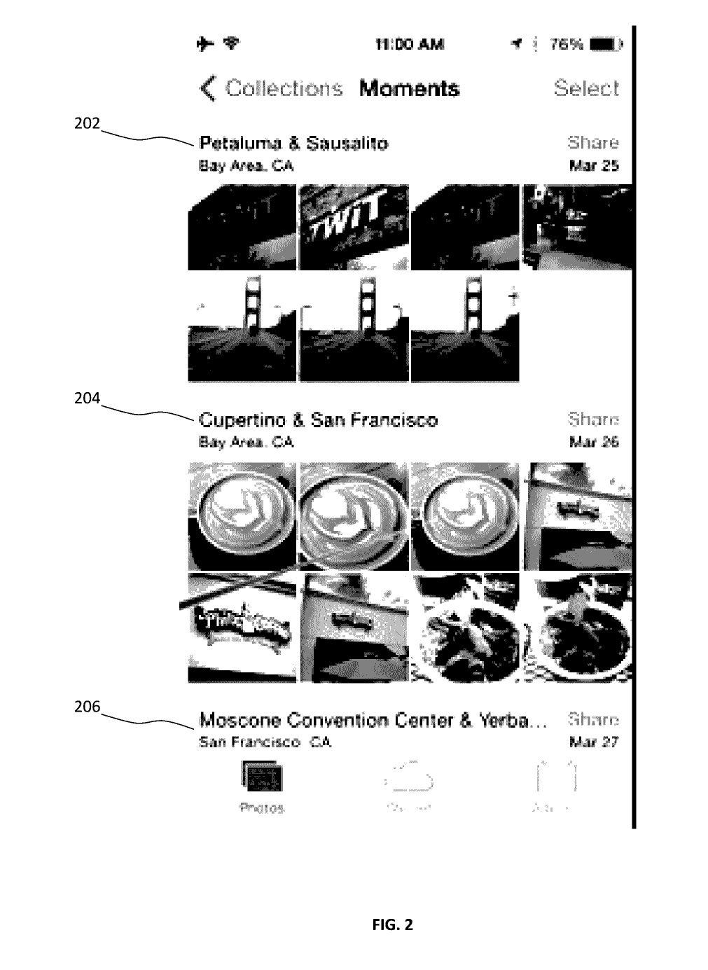

FIG. 2 illustrates an example of a moment-view interface 200 for presenting a collection of media items based on the moment a media item is captured. The interface 200 includes a list view of image collections 202, 204, and 206. The image collections 202, 204, 206 include thumbnail versions of images presented with a description of the location where the images were captured and a date that the images were captured. The definitions and boundaries between moments can be improved using temporal data and location data to define moments more precisely and to partition moment collections into more specific moments.

Some embodiments of the present technology also involve using information about locations in which a user of an electronic device is frequently located to define moments.

An electronic device can include a geolocation system for identifying a location of the device, assessing the location, identifying an address near the location, performing a reverse address lookup to determine a place name associated with the address, etc. In some embodiments of the present technology, an electronic device is configured to log information about the device's location and identifying a group of frequent locations using a set of heuristics. The location information can be used to provide the user with other content of interest to them. For example, as explained below, frequent location data can be used to tag media content on another device when the media content does not include location data.

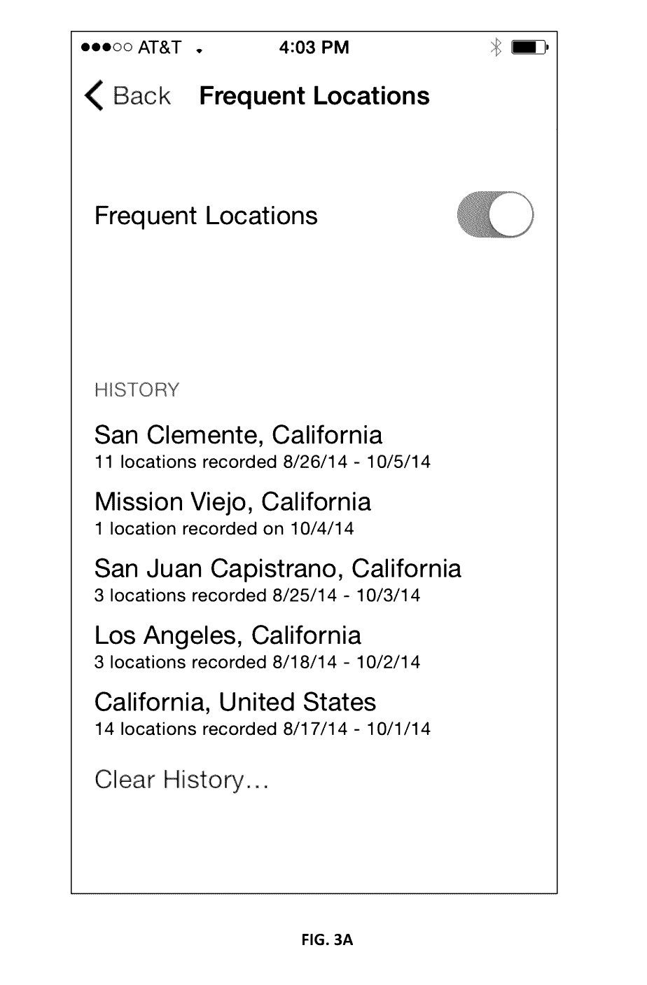

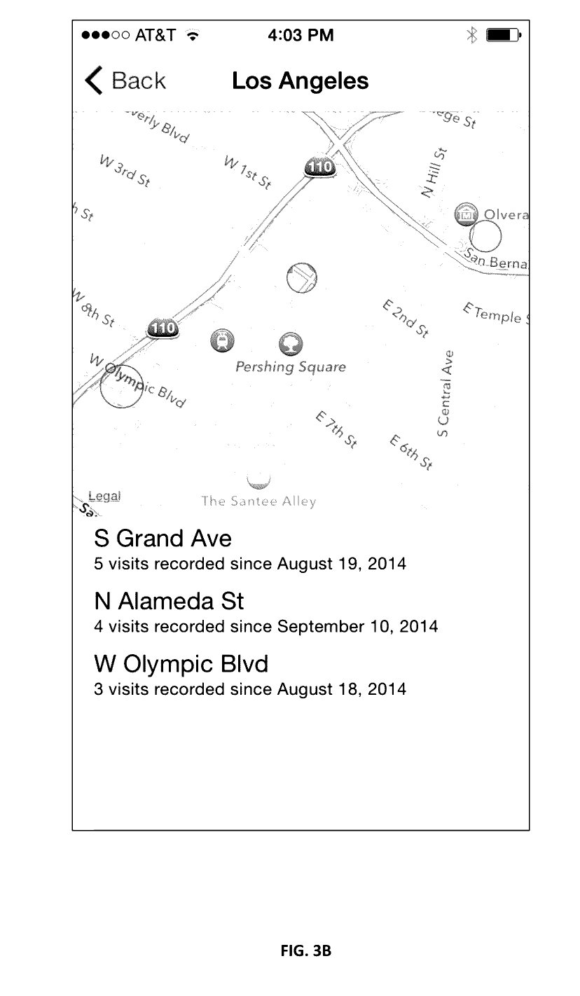

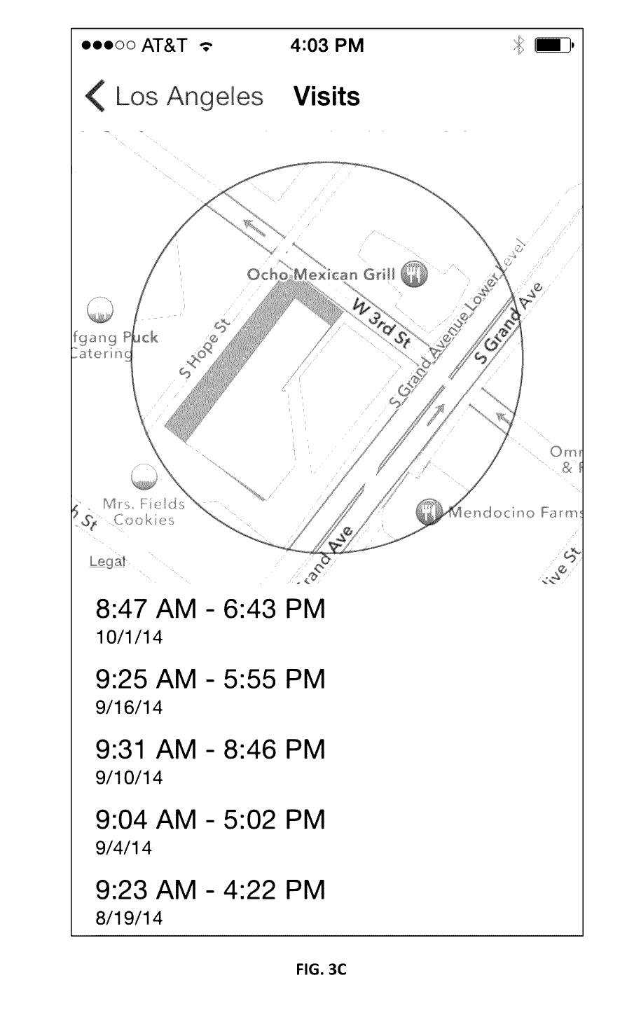

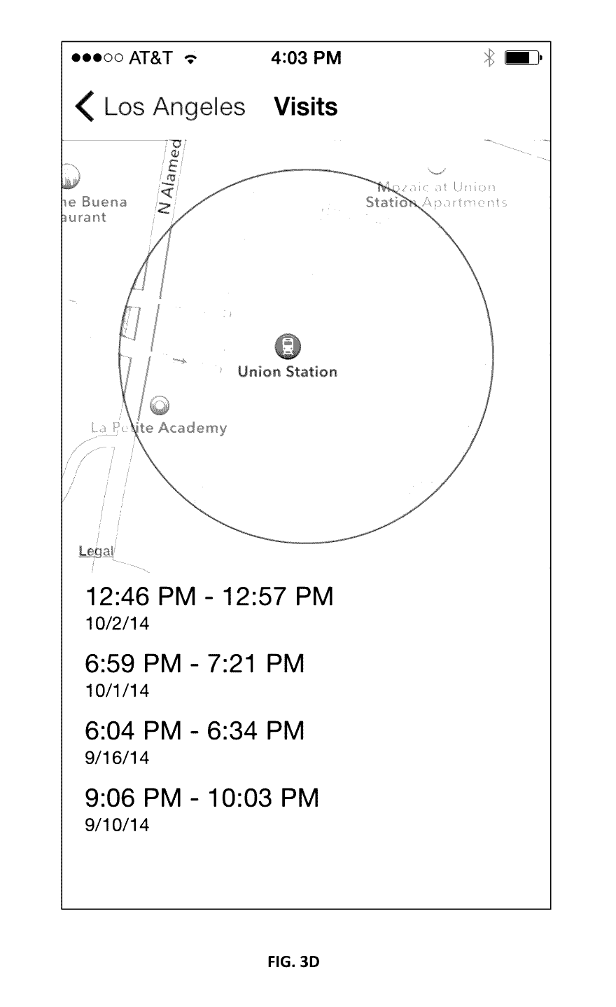

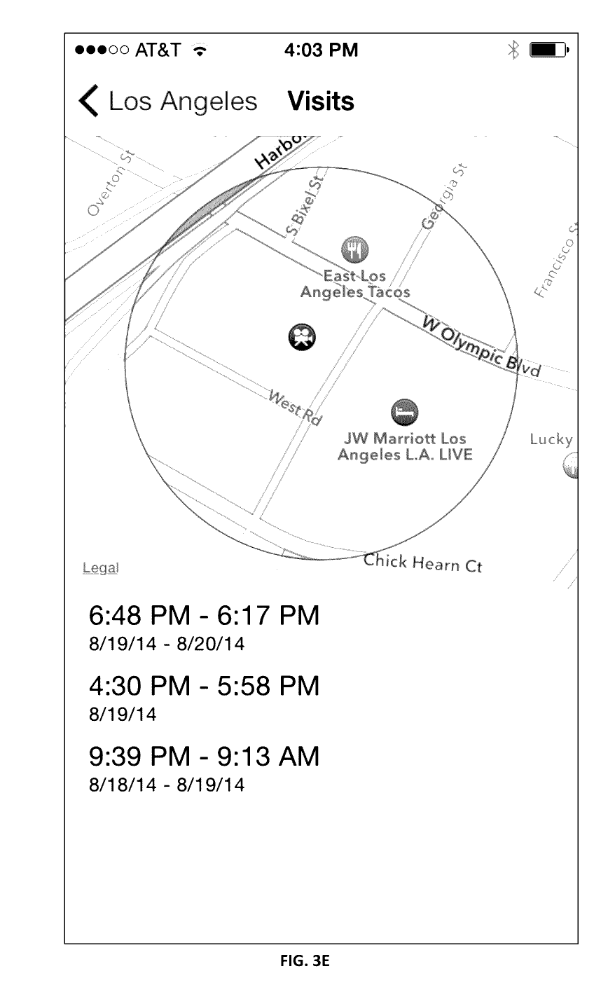

FIGS. 3A-3E illustrate examples of a graphical user interface for enabling and exploring a group of frequent location logged in an electronic device according to some embodiments of the present technology.

FIG. 3A shows a frequent locations interface 300 with a selection element 305 for allowing a user to turn a frequent location-logging feature off or on. In some embodiments, a user is required to positively select the selection element 305 to opt in to frequent location-logging feature. The frequent locations interface 300 can also show a history of selectable frequent location tabs 306, 307, 308, 309, 310 that can be selected to examine the frequent location in greater detail. The selectable frequent location tabs 306, 307, 308, 309, 310 can also list information about a number of more precise sub-locations contained within a frequent location. Selection of a frequent location tab can cause the electronic device to display a frequent sub-location interface providing a more detailed view of the frequent location.

FIG. 3B illustrates a frequent sub-locations interface 310 showing a map-view 315 of a user's frequent locations. The frequent locations interface 310 can list selectable tabs 316, 317, 318 of the more precise frequent sub-locations and plots 326, 327, 328 on the map-view 315 showing the location of the sub-locations within the larger frequent location. The selectable tabs 316, 317, 318 can also include information about a number of visits to the sub-location over a period of time. Selection of a sub-location tab can cause the electronic device to display a detailed map view and log interface.

FIGS. 3C, 3D, and 3E illustrate three detailed map views and log interfaces corresponding to the sub-location tabs 316, 317, 318. As shown, the detailed map views and log interfaces include logs of the dates and times spent in the locations and include an object on the map view showing the location of the sub-locations. In some cases, the objects are circles and the length of the radius of the circle can indicate how precise the electronic device has determined the location of the sub-location.

As explained above, a user can be given an option to opt in to frequent location-logging feature. Furthermore, a number of additional safeguards can be put into place to ensure that personal information about the location of a user is kept confidential. For example, the electronic device can be configured to strictly keep frequent location data on the device itself rather than share the data with an online storage and computing service. Additionally, the electronic device can be configured to delete frequent location log entries after short period of time.

As described above, one aspect of the present technology is the gathering and use of location data to improve the user experience related to photographs. The present disclosure contemplates that in some instances, this gathered data may include personal information data that uniquely identifies or can be used to contact or locate a specific person. Such personal information data can include location-based data, home addresses, work addresses, or any other identifying information.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location collection services, the present technology can be configured to allow users to select to “opt in” or “opt out” of participation in the collection of such data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, non-specific location information, such as information abstracted to a city, county, or regional level of detail could be used to tag photographs.

As explained above, information about locations in which a user of an electronic device is frequently located can be used to recognize the media item as belonging in a unique moment.

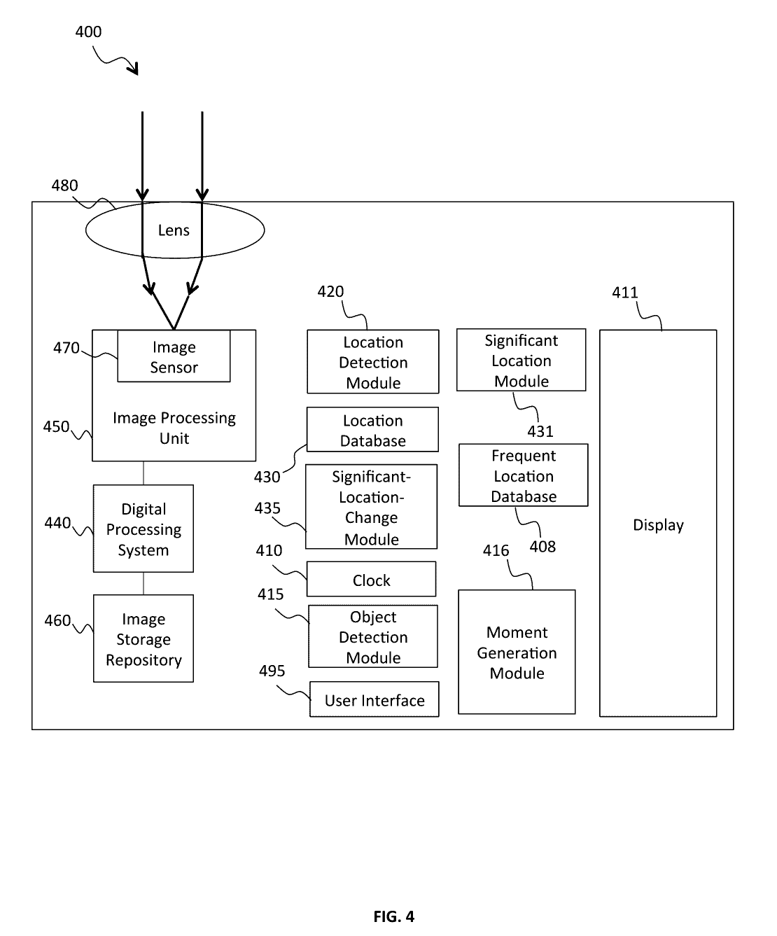

FIG. 4 illustrates an electronic device 400 for capturing images and generating moments based, at least in part, on frequent location data. The electronic device 400 includes a lens 480, an image sensor 470, and an image-processing unit 450. The image-processing unit 450 receives image data from the image sensor 470 and a digital processing system 440 processes the image data into a captured image and stores captured images in an image storage repository 460.

The electronic device 400 includes a clock 410, a location detection module 420, a location database 430, a significant-location-change module 435 for determining when the electronic device makes significant location changes, an object detection module 415, a user interface 495, and a moment generation module 416.

The significant-location-change module 435 can use location data to determine when the electronic device 400 makes a significant location change and create a significant location tag for the media items captured at locations on either side of the location transition. The a moment generation module 416 can then use significant location tags to recognize the media item as belonging in a unique moment. To avoid the ability to infer behavioral patterns and to ensure that user privacy is protected a new significant location tag can be generated for each significant location transition even if the location is the same as a previously visited location.

Additionally, the electronic device includes a frequent location database 408 and a significant location module 431. The frequent location database 408 contains frequent location information logged using the electronic device 400. The significant location module 431 determines when a location is significant enough to generate a unique moment and to partition a collection of images by unique moments. For example, in some embodiments of the present technology, the significant location module 431 can determine that a location is significant if it has been visited for a predetermined period of time, as determined by the location detection module 420. The significant location module 431 can also receive, via the location detection module 420, information about locations and determine whether the location is a known significant location. For example, the significant location module 431 can receive location use reverse geocoding techniques to determine that a location is a known significant location (e.g. a popular tourist destination). The significant location module 431 can also determine when a location is a familiar area or an area of personal significance (e.g. “home”).

In some embodiments, the significant location module 431 determines that a location is significant when the electronic device has both made a significant location change from the first time to the second time and determines that an image from the location recorded at the second time is a frequently visited location.

Additionally, the significant location module 431 can determine that the act of leaving a significant location is, in of itself, indicative of a media items captured after leaving the significant location as belonging in a unique moment.

Using information from the significant-location-change module 435, significant location module 431, the a moment generation module 416 can recognize certain media items as belonging in a unique moment and to partition a collection of images stored in the image storage repository 460 using the unique moments.

Those with ordinary skill in the art having the benefit of this disclosure will readily appreciate that a wide variety of methods exist for using frequent location information to generate moments. In one illustrative example, the electronic device examines temporal information for a group of images and determines that images with timestamps having a predetermined closeness in time belong to the same moment. In some embodiments, the moment generation module 116 determines that the electronic device has both made a significant location change from the first time to the second time and determines that an image from the location recorded at the second time a frequently visited location and the a moment generation module 416 tags the image with the unique moment tag and partitions a collection of images stored in the image storage repository 460 using the unique moment.

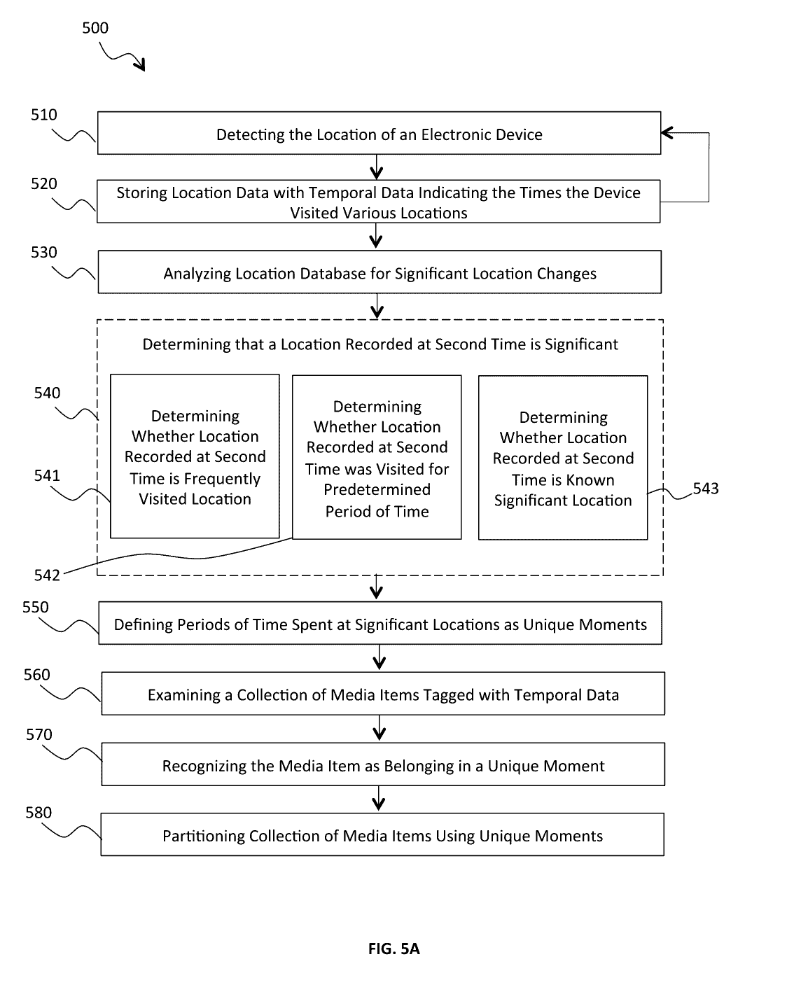

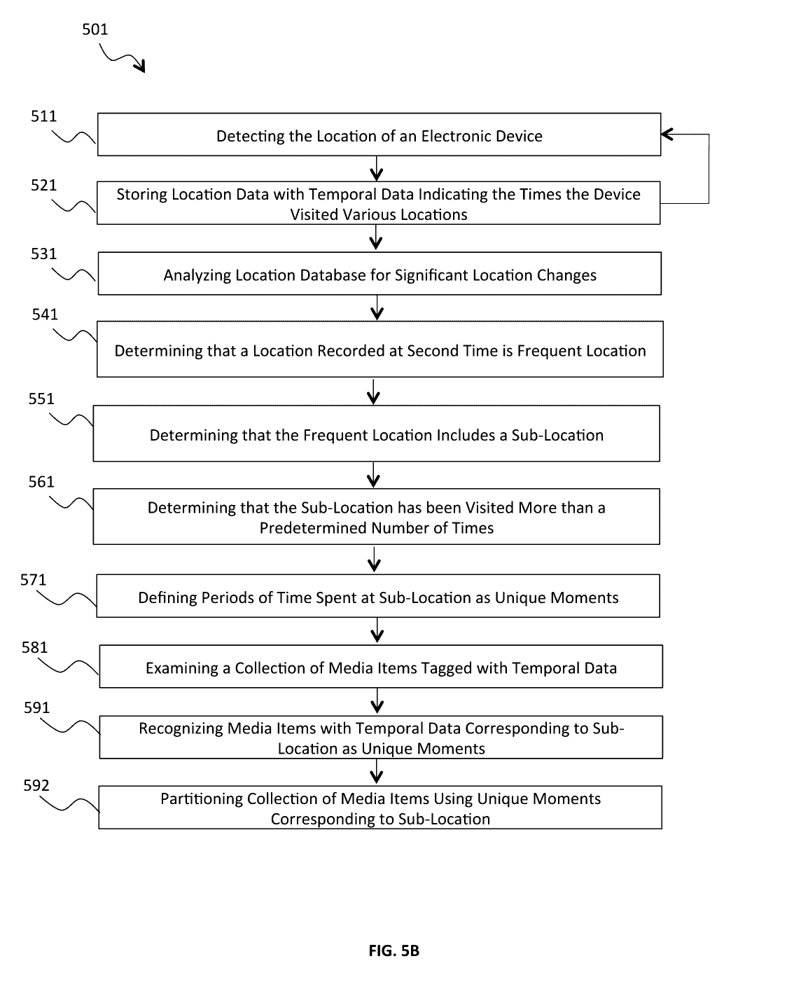

FIG. 5A illustrates a method 500 of generating moments using frequent location data according to some embodiments of the present technology. The method 500 involves detecting the location of an electronic device 510 and storing the location data along with temporal data indicating the times the electronic device visited various locations 520.

Next, the method 500 involves analyzing a location database 530 to determine that the electronic device has both made a significant location change and that the location recorded at the second time is a significant location 540.

Determining that the location recorded at the second time is a significant location 540 can involve determining that the location is a location that is visited for at least a predetermined period of time 542.

Determining that the location recorded at the second time is a significant location 540 can involve determining that the location is a known significant location 543 (e.g. a popular tourist destination, ‘home’, etc.).

Additionally, determining that the location recorded at the second time is a significant location 540 can involve determining that the location is a frequently visited location 541. For example, the electronic device can determine that it has made a significant location change from a first time to a second time. Next, the electronic device can query the frequent location database for any information about the location at the second time. When the location at the second time is a frequently visited location (or a frequently visited sub-location within a frequently visited location, as explained below), the electronic device can determine that the location is significant.

The method 500 also involves defining periods of time spent at a significant location as a unique moment 550, examining a collection of media items tagged with temporal data (e.g. creation time) 560, and recognizing the media item as belonging in a unique moment 570 when the media item's temporal information overlaps the period of time spent in the significant location causing the unique moment to be defined. Finally, the method 500 involves partitioning a collection of media items stored in the media storage by unique moments 580.

As explained above, a frequent location can include more precise sub-locations. For example, as the user of a camera begins to spend a lot of time in a place, he can begin to develop other locations in the city into significant locations of their own. In turn, a group of photos taken in location previously determined to be significant (e.g. the frequently-visited city) can be further partitioned into more granular moments to reflect the independently significant sub-locations within the larger significant location.

FIG. 5B illustrates a method 501 of generating moments using frequent location data and sub-location data according to some embodiments of the present technology. The method 501 involve detecting the location of an electronic device 511, storing the location data along with temporal data indicating the times the electronic device visited various locations 521, analyzing a location database 531 to determine that the electronic device has made a significant location change, and determining that the location recorded at the second time is a frequent location 541.

Next, the method 501 involves determining that the frequent location includes one or more sub-locations 551, determining that the sub-location has been visited more than a predetermined number of times 561, and defining the periods of time at the sub-location as unique moments 571.

The method 501 also involves examining a collection of media items tagged with temporal data (e.g. creation time) 581, and recognizing the media item corresponding to the sub-location as a unique moment 591 when the media item's temporal information overlaps the period of time spent in the sub-location causing the unique moment to be defined, and partitioning a collection of media items stored in the media storage using unique moments 592 and the sub-locations.

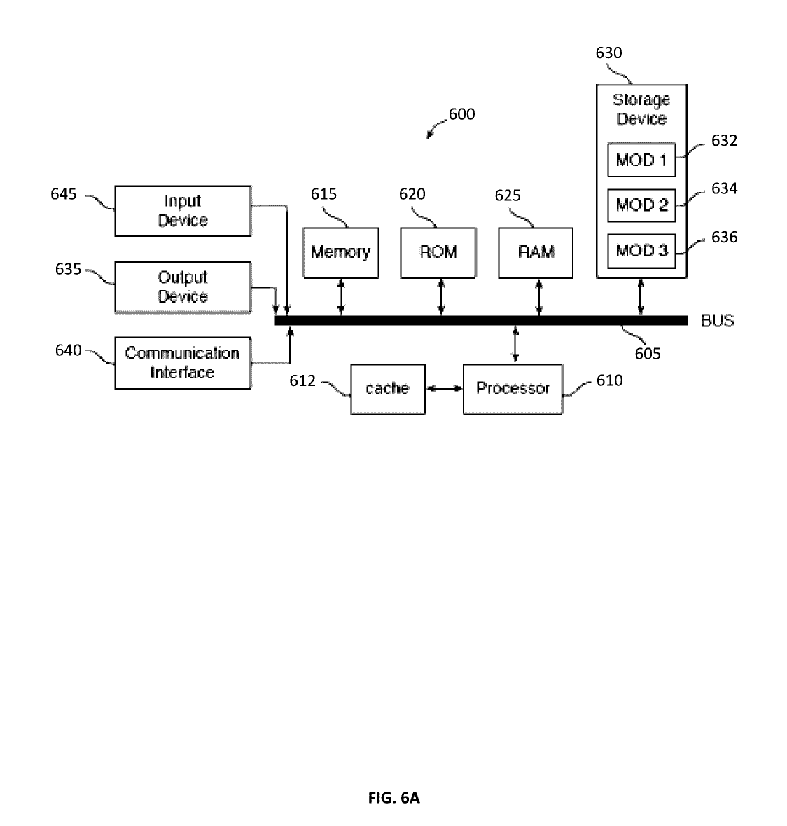

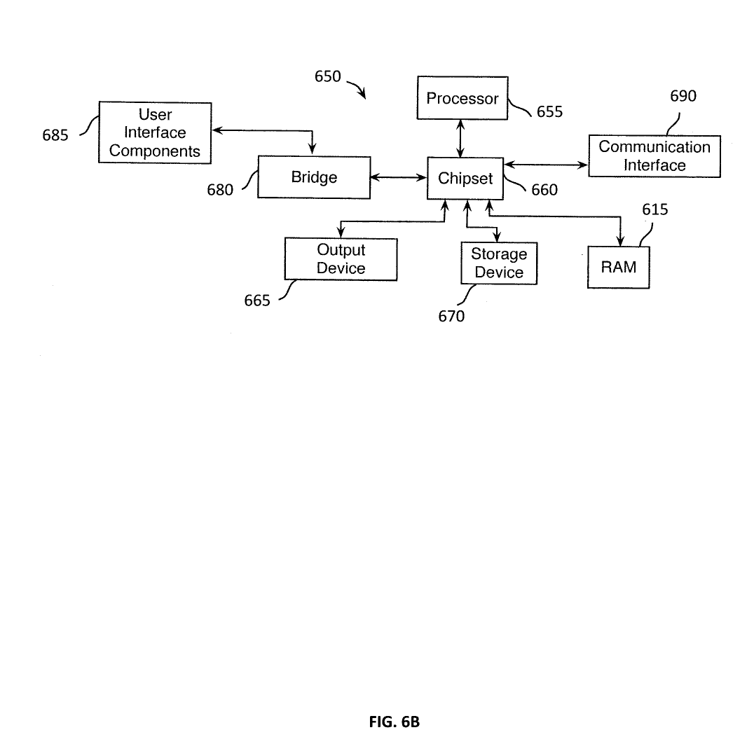

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

The various embodiments described above are provided by way of illustration only and should not be construed to limit the scope of the disclosure. Those skilled in the art will readily recognize various modifications and changes that may be made to the principles described herein without following the example embodiments and applications illustrated and described herein, and without departing from the spirit and scope of the disclosure.

We claim:

1. An electronic device comprising:
a location module configured to detect the location of the electronic device;
a location database configured to store the detected location of the electronic device at a first time and to store the detected location of the electronic device at a second time;
a significant location module configured to analyze the location database to determine that the electronic device has made a significant location change from the first time to the second time and that the location recorded at the second time is a significant location; and
a moment generation module configured to recognize the media item as belonging to a unique moment when the media item is associated with a creation time at the second time or after the second time,
wherein the moment generation module is further configured to partition a collection of media items stored in a media storage using the unique moment.

2. The electronic device of claim 1, wherein the location module is further configured to determine that the location is a frequently visited location, the electronic device further comprising:
a frequent location database storing information about a location that is frequently visited.

3. The electronic device of claim 2, wherein the significant location module determines that the location recorded at the second time is significant when the location is a frequently visited location.

4. The electronic device of claim 2, wherein the location module is further configured to determine when the electronic device moves away from a significant location to a new insignificant location, and wherein the moment generation module is further configured to recognize an additional media item as belonging to an additional unique moment when the media item is associated with the new insignificant location and to partition the collection of media items stored in a media storage using the new unique moment

5. The electronic device of claim 3, wherein the information about a location that is frequently visited includes location coordinates, a location name, a count indicating a number of times the electronic device visited the location, a log of the visits the electronic device made to the location, a date associated with each of the visits, and a duration indication associated with each of the visits.

6. The electronic device of claim 2, wherein the information about a location that is frequently visited includes a more precise, sub-location included in the location, and wherein the moment generation module is further configured to identify time spent at sub-location as a unique moment when the sub-location is visited a predetermined number of times and to partition the collection of media items stored in the media storage using a unique moment for the sub-location.

7. The electronic device of claim 1, wherein the significant location module determines that the location recorded at the second time is significant when the location is a location that is visited for at least a predetermined period of time.

8. The electronic device of claim 1, wherein the significant location module determines that the location recorded at the second time is significant when the location is a known significant location.

9. The electronic device of claim 1, wherein the moment generation module is further configured to recognize a media item as belonging to a unique moment when the media item is associated with a creation time a predetermined time before the second time.

10. A computer-implemented method comprising:
detecting the location of the electronic device using a location module in the electronic device;
storing, in a location database, location data describing detected locations of the electronic device at a first time and at a second time;
determining that the electronic device has made a significant location change from the first time to the second time and determining that the location recorded at the second time is a significant location;
recognizing a media item as belonging to a unique moment tag when the media item is associated with a creation time at the second time or after the second time; and
partitioning a collection of media items stored in the media storage using the unique moment.

11. The computer-implemented method of claim 10, further comprising:
determining that the location is a frequently visited location; and
storing location information describing the location that is frequently visited.

12. The computer-implemented method of claim 11, further comprising:
determining that the location recorded at the second time is significant when the location is a frequently visited location.

13. The computer-implemented method of claim 11, wherein the information describing a location that is frequently visited includes location coordinates, a location name, a count indicating a number of times the electronic device visited the location, a log of the visits the electronic device made to the location, a date associated with each of the visits, and a duration indication associated with each of the visits.

14. The computer-implemented method of claim 11, wherein the information describing a location that is frequently visited includes a more precise, sub-location included in the location, the method further comprising:
identifying time spent at sub-location as a unique moment when the sub-location is visited a predetermined number of times; and
partitioning the collection of media items stored in the media storage using a unique moment for the sub-location.

15. The computer-implemented method of claim 10, further comprising:
determining that the location recorded at the second time is significant when the location is a location that is visited for at least a predetermined period of time.

16. The computer-implemented method of claim 10, further comprising:
determining that the location recorded at the second time is significant when the location is a known significant location.

17. A non-transitory computer-readable storage medium storing instructions which, when executed by a computing device, cause the computing device to perform a method comprising:
detecting the location of the electronic device using a location module in the electronic device;
storing, in a location database, location data describing detected locations of the electronic device at a first time and at a second time;
determining that the electronic device has made a significant location change from the first time to the second time and determining that the location recorded at the second time is a significant location;
recognizing a media item as belonging to a unique moment tag when the media item is associated with a creation time at the second time or after the second time; and
partitioning a collection of media items stored in the media storage using the unique moment.

18. The non-transitory computer-readable storage medium of claim 17, the instructions further causing the processing device to perform the steps of:
determining that the location is a frequently visited location; and
storing location information describing the location that is frequently visited.

19. The non-transitory computer-readable storage medium of claim 18, the instructions further causing the processing device to perform the steps of:
determining that the location recorded at the second time is significant when the location is a frequently visited location.

20. The non-transitory computer-readable storage medium of claim 17, wherein the information describing a location that is frequently visited includes a more precise, sub-location included in the location, and wherein the instructions further causing the processing device to perform the steps of:
identifying time spent at sub-location as a unique moment when the sub-location is visited a predetermined number of times; and
partitioning the collection of media items stored in the media storage using a unique moment for the sub-location.
